(19) United States
(12) Patent Application Publication
(10) Pub. No.: US 2024/0212083 A1
(43) Pub. Date: Jun. 27, 2024

(54) TRAFFIC ANOMALY SCENE RECONSTRUCTION

(71) Applicant: Intel Corporation, Santa Clara, CA (US)

(72) Inventors: Frederik Pasch, Karlsruhe (DE); Cornelius Buerkle, Karlsruhe (DE); Fabian Oboril, Karlsruhe (DE)

(21) Appl. No.: 18/146,557

(22) Filed: Dec. 27, 2022

(51) Int. Cl. G06Q 50/26; G06F 21/62; G08G 1/01

(52) U.S. Cl. CPC G06Q 50/265; G06F 21/6254; G08G 1/0129; G08G 1/0133

(57) ABSTRACT

An apparatus, including: an interface operable to receive from traffic actors, information related to a traffic anomaly in a traffic scene; processing circuitry operable to: generate a digital twin of the traffic scene, wherein the digital twin is a virtual representation of the traffic scene; fuse the received traffic anomaly information; and reconstruct the traffic scene by the digital twin incorporating the fused traffic anomaly information.

### TECHNICAL FIELD

Aspects described herein generally relate to traffic anomaly scene reconstruction and, more particularly, to traffic anomaly scene reconstruction by a digital twin incorporating traffic anomaly information received from traffic actors.

### BACKGROUND

While in many traffic accidents the perpetrator can be identified, there are cases in which the legal situation defined by the traffic regulations is either unclear or a traffic participant tries to disprove guilt. Such situations often occur in crowded areas in which witnesses may be able to provide clarification. The search for witnesses is often arduous and unsuccessful, and information the witnesses provide might be not be complete. In addition, the introduction of autonomous vehicles decreases the number of potential human driver witnesses.

### BRIEF DESCRIPTION OF THE DRAWINGS

FIG. 1 illustrates a block diagram of a traffic anomaly reconstruction processing circuitry in accordance with aspects of the disclosure.

FIG. 2 illustrates a schematic diagram of traffic anomaly detection and reporting stage in accordance with aspects of the disclosure.

FIG. 3 illustrates a schematic diagram of a process for obtaining chained witness reports in accordance with aspects of the disclosure.

FIGS. 4A and 4B illustrate schematic diagrams of requesting data from previous timestamps in accordance with aspects of the disclosure.

FIG. 5A illustrates a block diagram of an overview of an example of a normal traffic scene in accordance with aspects of the disclosure.

FIG. 5B illustrates a flowchart of an example of a normal traffic scene procedure in accordance with aspects of the disclosure.

FIG. 5C illustrates a flowchart of an example procedure during a traffic anomaly in accordance with aspects of the disclosure.

FIG. 5D illustrates a flow diagram of an example of a procedure during a traffic anomaly scene reconstruction.

FIG. 6 illustrates a block diagram of a computing device in accordance with aspects of the disclosure.

### DESCRIPTION OF THE ASPECTS

The present disclosure is directed to an apparatus that generates a digital twin of a real traffic scene, fuses information related to a traffic anomaly in the real traffic scene, and reconstructs the traffic scene by the digital twin incorporating the fused traffic anomaly information. The apparatus identifies traffic anomaly participants and potential witnesses in a privacy-aware manner using wireless proximity estimation, and then requests the information from the identified participants and potential witnesses, which may be sensor-equipped.

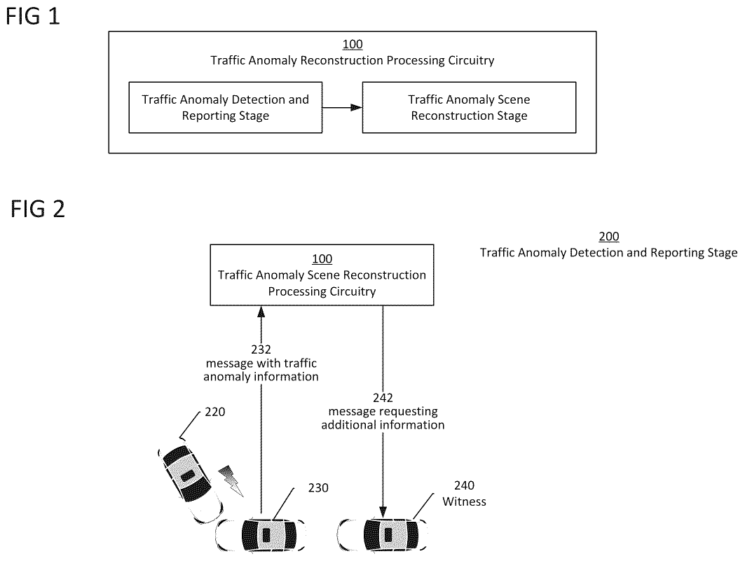

FIG. 1 illustrates a block diagram of a traffic anomaly reconstruction processing circuitry 100 in accordance with aspects of the disclosure.

By way of overview, the traffic anomaly reconstruction processing circuitry 100 comprises two stages—traffic anomaly detection and reporting, and traffic anomaly scene reconstruction stage. The traffic anomaly detection and reporting stage identifies traffic anomalies and stores from traffic actors (e.g., vehicles, pedestrians with smartphones, vulnerable road users, etc.) information related to the traffic anomaly in a real traffic scene. The traffic anomaly reconstruction stage generates a digital twin of the real traffic scene, fuses the received traffic anomaly information, and reconstructs the traffic anomaly scene by the digital twin incorporating the fused traffic anomaly information. The traffic anomaly reconstruction processing circuitry 100 is privacy-aware and may accelerate work of investigators.

### I. Traffic Anomaly Detection and Reporting Stage

During the traffic anomaly detection and reporting stage, the traffic anomaly reconstruction processing circuitry 100 applies known object detection and tracking algorithms to monitor the traffic scene. A traffic anomaly may be an accident/crash between traffic actors (e.g., vehicles and/or vulnerable road users), close encounters (e.g., cutting in, taking right of way, endangering other traffic actors), a threat of safety in general, or the like. The traffic anomaly reconstruction processing circuitry 100 detects and reports traffic anomalies for traffic anomaly scene reconstruction. Portions of the processing circuitry 100 might be deployed in the edge/cloud, within a traffic actor, or within a mobile device such as a smartphone. The processing circuitry 100 uses available sensors to either gather information about the traffic scene (e.g., using camera or lidar) or a traffic actor itself (e.g., obtaining acceleration values from an inertial measurement unit (IMU)).

The processing circuitry 100 monitors a current state or behavior of traffic actors in order to detect a traffic anomaly. For example, the traffic anomaly could be a traffic actor exceeding a maximum tolerable acceleration/deceleration, abruptly changing direction in a manner that is not valid for a specific behavior model, an airbag deploying, or detecting an acoustic noise (e.g., from traffic actors colliding). The processing circuitry 100 might also apply behavior models to check the interaction between different traffic actors (e.g., vehicles), an example of such a behavior model being Responsibility-Sensitive Safety (RSS). Alternatively, the processing circuitry 100 may compare current traffic actor behavior with historic data using artificial intelligence to detect behavior that is abnormal.

FIG. 2 illustrates a schematic diagram of traffic anomaly detection and reporting stage 200 in accordance with aspects of the disclosure.

The traffic anomaly detection and reporting stage 200 description includes the traffic anomaly reconstruction processing circuitry 100, traffic actors 220 and 230 involved in a traffic anomaly (i.e., an accident), and a traffic anomaly witness traffic actor 240.

If a traffic anomaly is detected, traffic actor 230 sends a message 232 wirelessly to the traffic anomaly reconstruction processing circuitry 100, which may be located in the cloud/edge. This message 232 includes a traffic anomaly timestamp and other basic information such as an identifier, the global positioning service (GPS) position with direction, and, if sent by a traffic actor, traffic actor parameters, and if the traffic actor itself was involved. Traffic actor parameters may comprise dimensions, dynamics, previous trajectory, and for autonomous actors also future trajectory, for example. If the anomaly detection includes sensor support, the information may additionally include sensor setup information, including field of view, resolution, accuracy, etc. Also, the information could include a first estimation of the traffic anomaly location (e.g., in front of traffic actor) and its probability.

In addition to this information reporting, an internal data recorder within the traffic actor 230 may be requested to store within a non-volatile memory the sensor data for a particular timespan before and/or after the traffic anomaly. As the non-volatile memory may be a circular buffer, this request is to avoid losing relevant traffic anomaly information until the scene reconstruction is completed.

The traffic anomaly reconstruction processing circuitry 100 identifies a witness traffic actor 240 and may send a wireless message 242 to request additional information, such as Lidar data around particular position, data in particular timespan, images with particular GPS positions, and images that include the traffic-anomaly involved traffic actors 220 and 230. During the traffic anomaly detection and reporting stage, the processing circuitry 100 fuses traffic anomaly information it receives, wherein the fused information will be used for reconstructing the traffic anomaly scene.

Although relevant information is submitted to the processing circuitry 100, the amount of data could be kept to a minimum. For fleets or for customers of car insurance companies that agree to data usage, this approach is feasible. By requesting a user to approve any data submission, privacy concerns could be cleared, but with reduced comfort. A more privacy-aware approach discussed below.

### II. Traffic Anomaly Scene Reconstruction Stage

During the traffic anomaly scene reconstruction stage, the processing circuitry 100 receives messages 232 of detected traffic anomalies from connected processing circuitry (e.g., traffic actors 220, 230, and/or 240). When the processing circuitry 100 receives one or multiple detected anomalies, the processing circuitry 100 first identifies individual anomalies by considering timestamps and locations. This identification is important because multiple traffic actors might have reported the same traffic anomaly. If separate traffic anomalies are reported within a same vicinity, the traffic anomalies are combined into one scene reconstruction as, for example, a pileup comprises multiple related crashes.

Traffic anomaly scene reconstruction stage is started for each individual traffic anomaly. A digital twin of the real traffic anomaly scene is generated. The digital twin is a virtual representation of the real traffic scene. The traffic anomaly reconstruction processing circuitry 100 reconstructs the traffic anomaly scene by the digital twin incorporating the fused traffic anomaly information. If the reconstruction result is not initially meaningful, additional information (e.g., sensor data) may be requested from one or more traffic actors 220, 230 240. Possible reasons for the reconstruction result not being meaningful include a probability of outcome being below a particular threshold, particular timespans in traffic anomaly scene reconstruction could not be calculated due to missing sensor coverage, reports from multiple traffic actors being contradictory, only a single report received making verification not possible, and/or calculated behavior of traffic actors does not match assumptions or information on a prior course of events.

There are multiple possible traffic anomaly scene reconstruction approaches. Each approach may be combined with other approaches to achieve an optimal output. If infrastructure sensors are available, the sensors could be incorporated, and depending on the operator, be rated with a higher priority due to a higher confidence in validity.

### A. Spatio-Temporal Reconstruction

One traffic anomaly scene reconstruction approach incorporates previous and planned trajectories of traffic actors 220, 230, 240 in order to reconstruct the traffic anomaly scene. In addition, the digital twin could spawn a spatio-temporal point model, a dynamic model, or a reference model that defines a maximum behavior of one or more of the traffic actors. Also, dimensions, maps, and other aspects could be included in the reconstruction. This traffic anomaly reconstruction might fail if there are no other traffic actors, in which case the situation necessitates a different approach.

### B. Object List Fusion

Another approach is to use object lists from the traffic actors 220, 230, 240, and fuse the object lists together. Object lists allow the detection of traffic actors that did not report to the processing circuitry 100, and will result in a better representation of the real traffic anomaly scene. The object detection and fusion algorithms might introduce errors, and thus a combination with other traffic anomaly scene reconstruction approaches may be advisable.

### C. Raw Sensor Fusion

Sensor data fusion, using known algorithms (e.g., multiple lidar sensors), is another option for traffic anomaly reconstruction.

### D. Request Chained Witness Reports

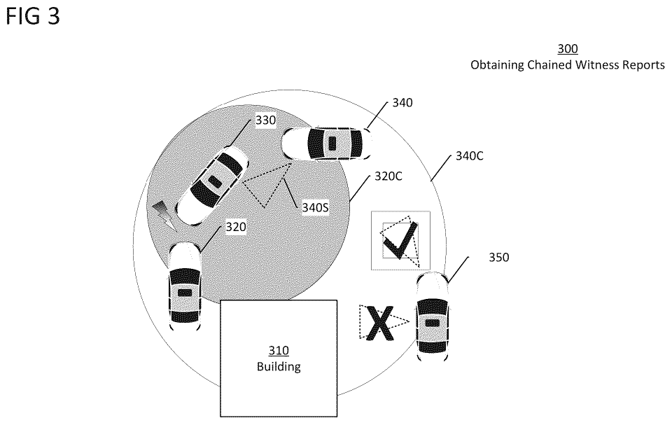

FIG. 3 illustrates a schematic diagram of a process for obtaining chained witness reports 300 for traffic anomaly scene reconstruction in accordance with aspects of the disclosure.

If the reliability of information cannot be proven by requested witness reports received initially, additional witness reports may be requested. In addition to utilizing the proximity snapshot of the traffic anomaly participants, the processing circuitry 100 may request proximity snapshots of witnesses in order to prove the reliability of information in the initial reports.

For example, traffic actors 320 and 330 are involved in an accident that sensors 340S of traffic actor 340 captures. Traffic actor 320 detects the proximity (within circle 320C) of the witness traffic actor 340 and requests a witness report. If that report with sensor data is not sufficient to ensure reliability (e.g., inaccurate position), the traffic anomaly reconstruction processing circuitry 100 might query a second-level witness report of traffic actor 350 which is in proximity of traffic actor 340 within circle 340C. Although traffic actor 350 did not see the accident due to the building 310, it can prove the spatio-temporal behavior of traffic actor 340 in order to prove its reliability.

This procedure may be chained in multiple levels of witness requests until the traffic anomaly scene can be reconstructed reliably. If information is missing, for example, for a specific maneuver or within a specific area of the road, this is also stored. The result is a traffic anomaly scene description which shows the overall reliability of information and can be used by investigators to identify the root cause of the traffic anomaly.

### E. Request Additional Data

If traffic anomaly scene reconstruction is missing information, the traffic anomaly reconstruction processing circuitry 100 tries to request sensor data from involved traffic actors.

### 1. Request Additional Sensor Data

As the sensor models of the traffic actors are known, requested sensor frames may be calculated and requested from the traffic actors.

### 2. Request Data from Previous Timestamps

In addition to requesting information from traffic actors that are directly involved in the traffic anomaly, it is also possible to use the current state of the traffic anomaly scene reconstruction to go back in time in order to identify other traffic actors that might be able to provide information. Sensor data investigation involves contacting those traffic actors to request further data. If these traffic actors are connected to the processing circuitry 100, identification is simple. If not, there are other ways of contacting these traffic actors.

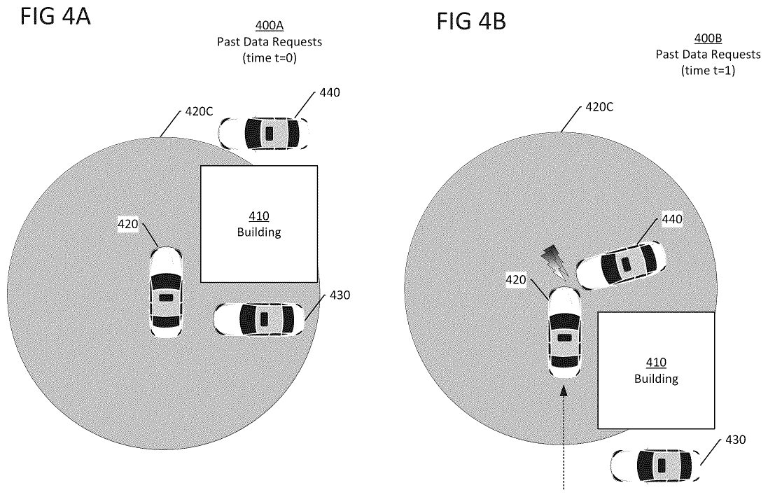

FIGS. 4A and 4B illustrate schematic diagrams of requesting data from previous timestamps 400 in accordance with aspects of the disclosure, FIG. 4A being for time t=0, and FIG. 4B being for time t=1.

Traffic actor 420 is driving straight. In FIG. 4A, traffic actor 420 is next to the traffic actor 430 at time t=0. In FIG. 4B at later time t=1, the traffic anomaly traffic actor 430 is no longer near traffic actor 420. Although traffic actor 430 is not able to provide information about the moment the traffic anomaly with traffic actor 440 occurs due to building 410 obstructing its view, the traffic anomaly reconstruction processing circuitry 100 requests traffic actor 430 to provide information about the speed of traffic actor 420 at previous time t=0, and therefore possible speed violations prior to the traffic anomaly.

### III. Privacy-Aware Data Sharing Approach

The traffic anomaly reconstruction processing circuitry 100 leverages temporary exposure keys that have been used to fight COVID-19 in a privacy-aware manner, by extending this concept in detecting potential traffic anomalies, identifying witnesses, and gathering traffic anomaly information for investigation.

User smartphones exchange privacy-preserving anonymous identifier beacons whenever in reach, also capturing the signal strength and therefore the distance. On a positive diagnosis in the case of CIVID-19, the infected person uploads his list of owned identifiers. A positive COVID-19 test leads to an anonymized report in a central system. The smartphone of a potentially infected person periodically downloads a list of positive identifiers and compares the positive identifiers with the identifiers that the smart phone collected over time. The person is then made aware of the contact.

This privacy-preserving approach of sharing anonymous identifiers is used herein in the context of traffic anomalies. Beside the proximity to other traffic actors, additional data is gathered locally using anonymous identifiers, but not shared in order to preserve privacy. On request and with consent of either the user or, for example, a fleet manager, data could be uploaded in order to support investigation and act as a witness report. This is similar to today's traffic anomaly investigation where human witnesses typically need to reveal their identity, but extended by the many advantages that sensor data can provide.

The traffic anomaly reconstruction processing circuitry 100 also may include additional features. A ring buffer may be used during normal operation to reduce the amount of stored information. Automatic traffic anomaly detection (e.g., using the same in-traffic actor sensors as the airbag) may be used to broadcast a traffic anomaly detection message (i.e., a trigger message) from a traffic actor involved in the traffic anomaly to other traffic actors to trigger a safe storage of the current content of the ring buffer in each device, that is, information related to the traffic anomaly.

Additionally, a service could support traffic anomaly investigation by recreating a complex scene with multiple actors using a proximity log and available sensor data. And if a portable wireless device is located within one of the traffic actors, group the portable wireless device with the traffic actor. For example, in the case of autonomous actor such as a robo-taxi, passenger smartphones located in the robo-taxi could be grouped with the robo-taxi).

### IV. Example of Normal Operation Phase, Traffic Anomaly Phase, and Traffic Anomaly Scene Reconstruction Phase

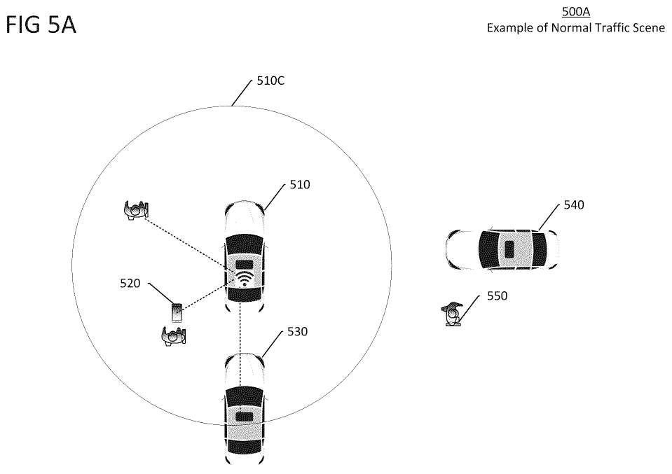

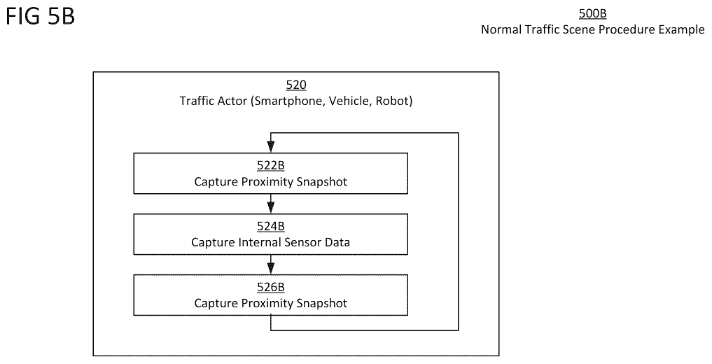

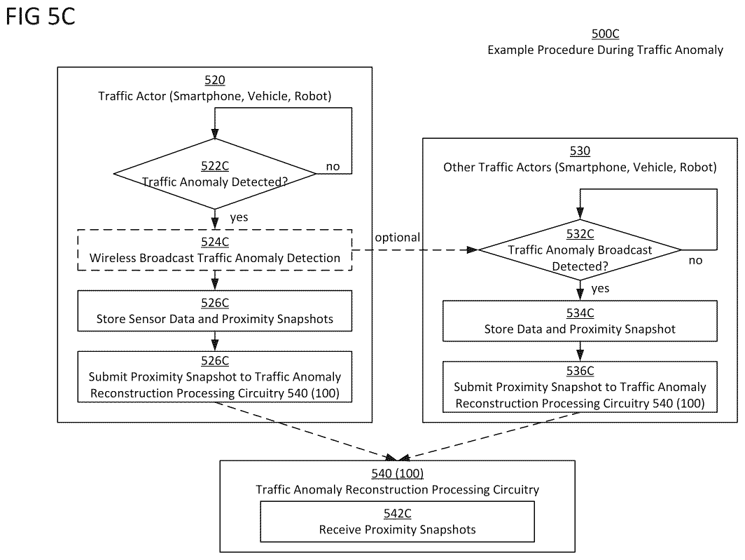

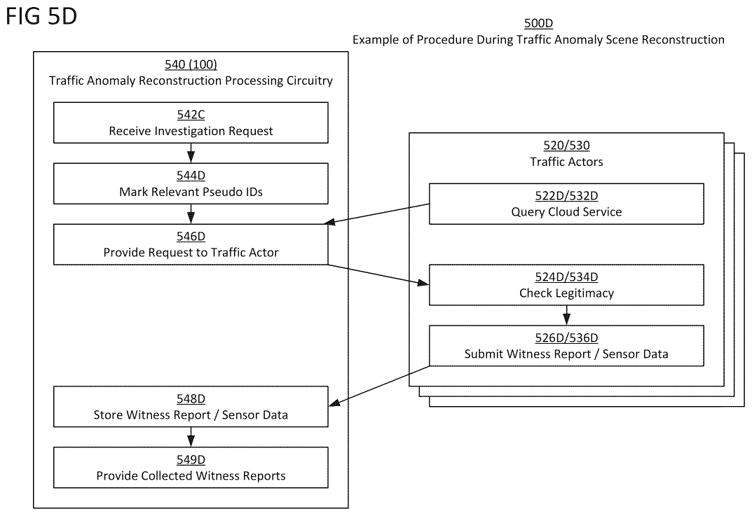

FIGS. 5A-5D illustrate examples of procedures during a normal operation phase, a traffic anomaly phase, and a traffic anomaly scene reconstruction phase. This example is in addition to, and not any limitation of, the aspects described above.

### A. Example of Normal Operation Phase

FIG. 5A illustrates a block diagram of an overview of an example of a normal traffic scene 500A in accordance with aspects of the disclosure. FIG. 5B illustrates a flowchart of an example of a normal traffic scene procedure 500B in accordance with aspects of the disclosure. A normal traffic scene in this example is one without any significant traffic anomalies.

During normal operation, traffic actors and/or pedestrians perform their usual route execution. The pedestrians with mobile devices and/or other traffic actors with computing devices, equipped with a wireless transmitter (e.g., Bluetooth or Wi-Fi), continuously capture proximity snapshots. As discussed above, these proximity snapshots may be captured in a privacy-aware manner using pseudo-identifications. The snapshots include information about which other mobile devices and/or other traffic actors are in a vicinity close enough to be a potential witness, but might also include more precise information about relative location. The relative location could, for example, be obtained using multi-antenna setups and triangulation.

A pedestrian (one of the traffic actors) with a mobile device 520 in the center of the circle 510C captures proximity of other traffic actors 510 using pseudo-identifications (Step 522B). More specifically, the pedestrian 520 in the lower left corner uses a smartphone to take video. And a traffic actor 530 has active front facing cameras to capture snapshots (526B). A traffic actor 540 and pedestrian 550 are not within the circle 510C, and thus are not within a proximity of the traffic actor 510.

Mobile devices might capture internal sensor data, such as acceleration, GPS, camera images, and/or object lists (e.g., from a perception system in an autonomous traffic actor) similar to existing data recording approaches (Step 524B). Data and the proximity snapshots are stored, for example, in a ring buffer for a particular timespan.

### B. Example of Traffic Anomaly Phase

FIG. 5C illustrates a flowchart of an example procedure 500B during a traffic anomaly in accordance with aspects of the disclosure.

When a traffic anomaly occurs, the involved traffic actor 520 detects the traffic anomaly either automatically by analyzing sensor data, or manually by user reporting (Step 522C). If the traffic actor 520 is involved in the traffic anomaly, existing crash detection mechanisms could be used, for example, sensors that trigger an airbag. For pedestrians and bicyclists, an automatic traffic anomaly detection might occur by analyzing accelerations received from a gyroscope within a smartphone. A human could manually trigger a traffic anomaly report using a smartphone app or a traffic actor interface. If the automatic traffic anomaly detection has a low threshold, a report could be issued even when there was no traffic anomaly; this low threshold ensures that the likelihood for false-negative reports is minimized.

After a traffic anomaly is detected (Step 522C), several actions are triggered. One action is storing existing and relevant sensor data in a non-volatile memory (Step 526C). This includes data that was captured when the traffic anomaly occurred, but might also include data that was captured prior. The available timespan is depending on the ring buffer that is filled during normal operation. The data comprises proximity snapshots and might include sensor data relevant for scene reconstruction.

Another action is a wireless broadcast from the traffic actor 520 to inform the other traffic actors 530 about the detected traffic anomaly (Steps 524C and 532C). This wireless broadcast might trigger the same behavior on those devices 530 to store the proximity snapshots and sensor data in a nonvolatile memory (Step 534C). If the proximity monitoring is executed continuously, this wireless broadcast could be optional, but due to limited size of the ring buffer there is a chance that relevant data is not available during reconstruction otherwise.

If no automatic traffic anomaly detection is available (e.g., pedestrian witness) the pedestrian witness may trigger the snapshot capturing manually using a smartphone.

Traffic actors 520, 530 that captured a proximity snapshot not only store it locally, but also submit the proximity snapshots to the traffic anomaly reconstruction processing circuitry 540(100) (Steps 526C and 536C). As the processing circuitry uses pseudo-identifiers, the snapshot submissions do not represent a privacy issue. Neither an immediate identification of users nor a localization is possible, only the relative positions between pseudo-identifications. The traffic anomaly reconstruction processing circuitry 540 (100), after receiving the snapshots (Step 542C), may begin a traffic anomaly scene reconstruction.

### C. Example of Traffic Anomaly Scene Reconstruction Phase

FIG. 5D illustrates a flow diagram of an example of a procedure during a traffic anomaly scene reconstruction 500D.

The traffic anomaly reconstruction processing circuitry 540 (100) receives an investigation request (i.e., a traffic anomaly scene reconstruction request) from either a legal/public authority, or from a traffic anomaly participant (Step 542C). Potential witnesses and traffic actors report their proximity snapshot only with pseudo-identifications, and thus direct contact is not possible. The traffic anomaly reconstruction processing circuitry 540 (100) marks the relevant pseudo-identifications with a flag (Step 544D(and attaches the witness request sent to traffic actors 520/530 (Step 546D). This is possible because the relevant pseudo-identifications are shared by the affected parties. The traffic actors 520/530 that are connected to the traffic anomaly reconstruction processing circuitry 540 (100) sporadically query the traffic anomaly reconstruction processing circuitry 540 (100) to check if their pseudo-identification is marked (Step 522D/532D). If their pseudo-identification is marked, the request is either automatically fulfilled or it is reported to the user (e.g. through smartphone app or traffic actor interface) and he or she decides if the request should be fulfilled (Step 526D/536D). A witness report might either be executed by a human (i.e., witness describes what he or she has seen) or by a traffic actor that captured data (e.g., camera on traffic actor or smartphone, combined with gyro information for orientation).

The request states for which point in time a witness report is being requested. The request might also include the requesting pseudo-identification in order to validate the legitimacy, that is, the traffic actor 520/530 could check if the requesting device was around at that point in time) (Step 524D/534D).

Different recipients of the report is possible. A common case would be legal authorities or a legal advisor that deal with the incident. To ensure the legitimacy of the recipient, a public-key cryptography approaches might be established.

If the witness approves the request, the available and relevant data is uploaded to the traffic anomaly reconstruction processing circuitry 540 (100) (Step 526D/536D). This traffic anomaly reconstruction processing circuitry 540 (100) collects and stores witness reports (Step 548D), and can provide these collected witness reports to the requester (e.g., legal authorities) (Step 549D).

### IV. Computing Device

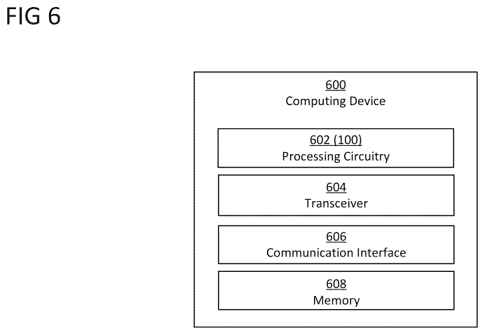

FIG. 6 illustrates a block diagram of a computing device 600 in accordance with aspects of the disclosure. The computing device 600 may be identified with a central controller and be implemented as any suitable network infrastructure component, which may be implemented as a cloud/edge network server, controller, computing device, etc. The computing device 600 may serve the traffic anomaly reconstruction processing circuitry 100 in accordance with the various techniques as discussed herein. To do so, the computing device 600 may include processing circuitry 602 (100), a transceiver 604, communication interface 606, and a memory 608. The components shown in FIG. 6 are provided for ease of explanation, and the computing device 600 may implement additional, less, or alternative components as those shown in FIG. 6.

The processing circuitry 602 may be operable as any suitable number and/or type of computer processors, which may function to control the computing device 600. The processing circuitry 602 may be identified with one or more processors (or suitable portions thereof) implemented by the computing device 600. The processing circuitry 602 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 602 may be operable to carry out instructions to perform arithmetical, logical, and/or input/output (I/O) operations, and/or to control the operation of one or more components of computing device 600 to perform various functions as described herein. The processing circuitry 602 may include one or more microprocessor cores, memory registers, buffers, clocks, etc., and may generate electronic control signals associated with the components of the computing device 600 to control and/or modify the operation of these components. The processing circuitry 602 may communicate with and/or control functions associated with the transceiver 604, the communication interface 606, and/or the memory 608. The processing circuitry 602 may additionally perform various operations to control the communications, communications scheduling, and/or operation of other network infrastructure components that are communicatively coupled to the computing device 600.

The transceiver 604 may be implemented as any suitable number and/or type of components operable to transmit and/or receive data packets and/or wireless signals in accordance with any suitable number and/or type of communication protocols. The transceiver 604 may include any suitable type of components to facilitate this functionality, including components associated with known transceiver, transmitter, and/or receiver operation, configurations, and implementations. Although depicted in FIG. 6 as a transceiver, the transceiver 604 may include any suitable number of transmitters, receivers, or combinations of these that may be integrated into a single transceiver or as multiple transceivers or transceiver modules. The transceiver 604 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 606 may be operable as any suitable number and/or type of components operable to facilitate the transceiver 604 receiving and/or transmitting data and/or signals in accordance with one or more communication protocols, as discussed herein. The communication interface 606 may be implemented as any suitable number and/or type of components that function to interface with the transceiver 604, such as analog-to-digital converters (ADCs), digital to analog converters, intermediate frequency (IF) amplifiers and/or filters, modulators, demodulators, baseband processors, etc. The communication interface 606 may thus work in conjunction with the transceiver 604 and form part of an overall communication circuitry implemented by the computing device 600, which may be implemented via the computing device 600 to transmit commands and/or control signals to execute any of the functions describe herein.

The memory 608 is operable to store data and/or instructions such that, when the instructions are executed by the processing circuitry 602, cause the computing device 600 to perform various functions as described herein. The memory 608 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 608 may be non-removable, removable, or a combination of both. The memory 608 may be implemented as a non-transitory computer readable medium storing one or more executable instructions such as, for example, logic, algorithms, code, etc.

As further discussed below, the instructions, logic, code, etc., stored in the memory 608 are represented by the various modules/engines as shown in FIG. 6. Alternatively, if implemented via hardware, the modules/engines shown in FIG. 6 associated with the memory 608 may include instructions and/or code to facilitate control and/or monitor the operation of such hardware components. In other words, the modules/engines as shown in FIG. 6 are provided for ease of explanation regarding the functional association between hardware and software components. Thus, the processing circuitry 602 may execute the instructions stored in these respective modules/engines in conjunction with one or more hardware components to perform the various functions as discussed herein.

### VI. Artificial Intelligence/Machine Learning

Various aspects described herein may utilize one or more machine learning models. The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The aspects are described with respect to a traffic environment. The disclosure is not limited in this respect. These aspects are applicable to other environments, such as factory environments with robots and other actors.

The techniques of this disclosure may also be described in the following examples.

Example 1. An apparatus, comprising: an interface operable to receive from traffic actors, information related to a traffic anomaly in a traffic scene; processing circuitry operable to: generate a digital twin of the traffic scene, wherein the digital twin is a virtual representation of the traffic scene; fuse the traffic anomaly information received from the traffic actors; and reconstruct the traffic scene by the digital twin incorporating the fused traffic anomaly information.

Example 2. The apparatus of example 1, wherein the processing circuitry is further operable to: reconstruct the traffic scene by the digital twin spawning a spatio-temporal point model, or spawning a dynamic model that defines a maximum behavior of one or more of the traffic actors.

Example 3. The apparatus of any one or more of examples 1-2, wherein the processing circuitry is further operable to: identify a traffic anomaly witness actor; request, for a timestamp at which the traffic anomaly occurred, additional information related to the traffic anomaly from the traffic anomaly witness actor; and receive the additional information from the traffic anomaly witness actor.

Example 4. The apparatus of any one or more of examples 1-3, wherein the traffic anomaly witness actor has an anonymous identifier, and the additional information is requested and received from the traffic anomaly witness actor using the anonymous identifier.

Example 5. The apparatus of any one or more of examples 1-4, wherein the request for the additional information is performed if the fused traffic anomaly information is insufficient to reconstruct the traffic scene.

Example 6. The apparatus of any one or more of examples 1-5, wherein the processing circuitry is further operable to: request sensor data from one or more of the traffic actors.

Example 7. The apparatus of any one or more of examples 1-6, wherein the processing circuitry is further operable to: identify individual traffic anomalies using timestamps and locations when the information is related to more than one traffic anomaly.

Example 8. The apparatus of any one or more of examples 1-7, wherein the processing circuitry is further operable to: broadcast a trigger message to the traffic actors to store the information related to the traffic anomaly, in response to receiving a traffic anomaly detection message from one or more of the traffic actors.

Example 9. The apparatus of any one or more of examples 1-8, wherein the processing circuitry is further operable to: group a portable wireless device with one of the traffic actors if the portable wireless device is located within this traffic actor.

Example 10. The apparatus of any one or more of examples 1-9, wherein the processing circuitry is located at the edge or in the cloud.

Example 11. The apparatus of any one or more of examples 1-10, wherein at least one of the traffic actors is an autonomous actor, and at least a portion of the information related to the traffic anomaly is sensor data received from the autonomous actor.

Example 12. The apparatus of any one or more of examples 1-11, wherein a portion of the information related to the traffic anomaly was sent by a traffic anomaly witness actor, in response to the traffic anomaly witness actor having received a traffic anomaly detection message from one or more of the traffic actors involved in the traffic anomaly.

Example 13. The apparatus of any one or more of examples 1-12, wherein the processing circuitry is further operable to: identify one or more potential traffic anomaly witness actors; request, from the one or more potential traffic anomaly witness actors, respective traffic anomaly witness actor reports; and receiving, from at least a portion of the one or more potential traffic anomaly witness actors, traffic anomaly witness actor reports.

Example 14. The apparatus of any one or more of examples 1-13, wherein the one or more potential traffic anomaly witness actors and the traffic anomaly witness actor reports are for a specific time at which the traffic anomaly occurred.

Example 15. The apparatus of any one or more of examples 1-14, wherein the traffic anomaly information comprises object lists of traffic actors or sensor data sensed by the traffic actors.

Example 16. A component, comprising: processing circuitry; and a non-transitory computer-readable storage medium including instructions that, when executed by the processing circuitry, cause the processing circuitry to: generate a digital twin of a traffic scene, wherein the digital twin is a virtual representation of the traffic scene; fuse information received from traffic actors and related to a traffic anomaly in the traffic scene; and reconstruct the traffic scene by the digital twin incorporating the fused information.

Example 17. The component of example 16, wherein the instructions cause the processing circuitry to: reconstruct the traffic scene by the digital twin spawning a spatio-temporal point model, or spawning a dynamic model that defines a maximum behavior of the traffic actors.

Example 18. The component of any one or more of examples 16-17, wherein the instructions cause the processing circuitry to: identify a traffic anomaly witness actor; request, for a timestamp at which the traffic anomaly occurred, additional information related to the traffic anomaly from the traffic anomaly witness actor; and receive the additional information from the traffic anomaly witness actor.

Example 19. The component of any one or more of examples 16-18, wherein the traffic anomaly witness actor has an anonymous identifier, and the additional information is requested and received from the traffic anomaly witness actor using the anonymous identifier.

Example 20. The component of any one or more of examples 16-19, wherein the instructions cause the processing circuitry to: identify individual traffic anomalies using timestamps and locations of the information, when the information is related to more than one traffic anomaly.

Example 21. The component of any one or more of examples 16-20, wherein the instructions cause the processing circuitry to: in response to receiving an automatic traffic anomaly detection message from at least one of the traffic actors, broadcast a trigger message to the traffic actors to store the information related to the traffic anomaly.

Example 22. The component of any one or more of examples 16-21, wherein at least one of the traffic actors is an autonomous actor, and at least a portion of the information related to the traffic anomaly is sensor data received from the autonomous actor.

Example 23. The component of any one or more of examples 16-22, wherein a portion of the information related to the traffic anomaly was sent by a traffic anomaly witness actor, in response to the traffic anomaly witness actor having received a traffic anomaly detection message from one or more of the traffic actors involved in the traffic anomaly.

Example 24. The component of any one or more of examples 16-23, wherein the instructions cause the processing circuitry to: identify potential traffic anomaly witness actors; request, from the identified potential traffic anomaly witness actors, traffic anomaly witness actor reports; and receiving, from the potential traffic anomaly witness actors, traffic anomaly witness actor reports.

Example 25. The component of any one or more of examples 16-24, wherein the identified potential traffic anomaly witness actors and the traffic anomaly witness actor reports are for a specific time at which the traffic anomaly occurred.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. An apparatus, comprising:
an interface operable to receive from traffic actors, information related to a traffic anomaly in a traffic scene;
processing circuitry operable to:
generate a digital twin of the traffic scene, wherein the digital twin is a virtual representation of the traffic scene;
fuse the traffic anomaly information received from the traffic actors; and
reconstruct the traffic scene by the digital twin incorporating the fused traffic anomaly information.

2. The apparatus of claim 1, wherein the processing circuitry is further operable to:
reconstruct the traffic scene by the digital twin spawning a spatio-temporal point model, or spawning a dynamic model that defines a maximum behavior of one or more of the traffic actors.

3. The apparatus of claim 1, wherein the processing circuitry is further operable to:
identify a traffic anomaly witness actor;
request, for a timestamp at which the traffic anomaly occurred, additional information related to the traffic anomaly from the traffic anomaly witness actor; and
receive the additional information from the traffic anomaly witness actor.

4. The apparatus of claim 3, wherein the traffic anomaly witness actor has an anonymous identifier, and the additional information is requested and received from the traffic anomaly witness actor using the anonymous identifier.

5. The apparatus of claim 3, wherein the request for the additional information is performed if the fused traffic anomaly information is insufficient to reconstruct the traffic scene.

6. The apparatus of claim 1, wherein the processing circuitry is further operable to:
request sensor data from one or more of the traffic actors.

7. The apparatus of claim 1, wherein the processing circuitry is further operable to:
identify individual traffic anomalies using timestamps and locations when the information is related to more than one traffic anomaly.

8. The apparatus of claim 1, wherein the processing circuitry is further operable to:
broadcast a trigger message to the traffic actors to store the information related to the traffic anomaly, in response to receiving a traffic anomaly detection message from one or more of the traffic actors.

9. The apparatus of claim 1, wherein the processing circuitry is further operable to:
group a portable wireless device with one of the traffic actors if the portable wireless device is located within this traffic actor.

10. The apparatus of claim 1, wherein the processing circuitry is located at the edge or in the cloud.

11. The apparatus of claim 1, wherein at least one of the traffic actors is an autonomous actor, and at least a portion of the information related to the traffic anomaly is sensor data received from the autonomous actor.

12. The apparatus of claim 1, wherein a portion of the information related to the traffic anomaly was sent by a traffic anomaly witness actor, in response to the traffic anomaly witness actor having received a traffic anomaly detection message from one or more of the traffic actors involved in the traffic anomaly.

13. The apparatus of claim 1, wherein the processing circuitry is further operable to:
identify one or more potential traffic anomaly witness actors;
request, from the one or more potential traffic anomaly witness actors, respective traffic anomaly witness actor reports; and
receiving, from at least a portion of the one or more potential traffic anomaly witness actors, traffic anomaly witness actor reports.

14. The apparatus of claim 13, wherein the one or more potential traffic anomaly witness actors and the traffic anomaly witness actor reports are for a specific time at which the traffic anomaly occurred.

15. The apparatus of claim 1, wherein the traffic anomaly information comprises object lists of traffic actors or sensor data sensed by the traffic actors.

16. A component, comprising:
processing circuitry; and
a non-transitory computer-readable storage medium including instructions that, when executed by the processing circuitry, cause the processing circuitry to:
generate a digital twin of a traffic scene, wherein the digital twin is a virtual representation of the traffic scene;
fuse information received from traffic actors and related to a traffic anomaly in the traffic scene; and
reconstruct the traffic scene by the digital twin incorporating the fused information.

17. The component of claim 16, wherein the instructions cause the processing circuitry to:
reconstruct the traffic scene by the digital twin spawning a spatio-temporal point model, or spawning a dynamic model that defines a maximum behavior of the traffic actors.

18. The component of claim 16, wherein the instructions cause the processing circuitry to:
identify a traffic anomaly witness actor;
request, for a timestamp at which the traffic anomaly occurred, additional information related to the traffic anomaly from the traffic anomaly witness actor; and
receive the additional information from the traffic anomaly witness actor.

19. The component of claim 18, wherein the traffic anomaly witness actor has an anonymous identifier, and the additional information is requested and received from the traffic anomaly witness actor using the anonymous identifier.

20. The component of claim 16, wherein the instructions cause the processing circuitry to:
identify individual traffic anomalies using timestamps and locations of the information, when the information is related to more than one traffic anomaly.

21. The component of claim 16, wherein the instructions cause the processing circuitry to:
in response to receiving an automatic traffic anomaly detection message from at least one of the traffic actors, broadcast a trigger message to the traffic actors to store the information related to the traffic anomaly.

22. The component of claim 16, wherein at least one of the traffic actors is an autonomous actor, and at least a portion of the information related to the traffic anomaly is sensor data received from the autonomous actor.

23. The component of claim 16, wherein a portion of the information related to the traffic anomaly was sent by a traffic anomaly witness actor, in response to the traffic anomaly witness actor having received a traffic anomaly detection message from one or more of the traffic actors involved in the traffic anomaly.

24. The component of claim 16, wherein the instructions cause the processing circuitry to:
identify potential traffic anomaly witness actors;
request, from the identified potential traffic anomaly witness actors, traffic anomaly witness actor reports; and
receiving, from the potential traffic anomaly witness actors, traffic anomaly witness actor reports.

25. The component of claim 24, wherein the identified potential traffic anomaly witness actors and the traffic anomaly witness actor reports are for a specific time at which the traffic anomaly occurred.
